(19) United States
(12) Patent Application Publication
(10) Pub. No.: US 2015/0346550 A1
(43) Pub. Date: Dec. 3, 2015

(54) DISPLAY PANEL AND DISPLAY DEVICE

(71) Applicants: BOE Technology Group Co., Ltd., Beijing (CN); Beijing BOE Display Technology Co., Ltd., Beijing (CN)

(72) Inventor: Yupeng Wang, Beijing (CN)

(21) Appl. No.: 14/499,410

(22) Filed: Sep. 29, 2014

(30) Foreign Application Priority Data
May 27, 2014 (CN) 201410228829.7

(51) Int. Cl. G02F 1/1335; G02F 1/1337

(52) U.S. Cl. CPC G02F 1/133606; G02F 1/133514; G02F 1/133526; G02F 1/133528; G02F 1/1337; G02F 1/133512; G02F 2001/133607

(57) ABSTRACT

The disclosure of the present invention provides a display panel and a display device. A display panel comprises a color filter substrate comprising a plurality of sub pixels. Each sub pixel is provided with a color filter layer therein. The display panel further comprises a light condensing substrate at one side of the color filter substrate facing a light source, and a light condensing structure is arranged at a corresponding position onto the light condensing substrate to the color filter layer.

### CROSS-REFERENCE TO RELATED APPLICATION

This application claims the benefit of Chinese Patent Application No. 201410228829.7 filed on May 27, 2014 in the State Intellectual Property Office of China, the whole disclosure of which is incorporated herein by reference.

### BACKGROUND OF THE INVENTION

1. Field of the Invention

The present disclosure relates to a technical field of display, more particularly, to a display panel and a display device.

2. Description of the Related Art

Liquid crystal display is one type of the display device which is planar and ultrathin. It mainly includes a backlight module and a display panel. The display panel typically includes an array substrate, a color filter substrate and a liquid crystal molecular layer between the array substrate and the color filter substrate. During the display of the liquid crystal display, light rays emitted from the backlight module successively pass through the array substrate, the liquid crystal molecular layer, and the color filter substrate, or the like.

As shown in FIG. 1, since the color filter substrate is provided with a plurality of sub pixels, wherein a color filter layer 1′ is provided within the sub pixel and a black matrix 2′ is arranged between the sub pixels. Since the light rays emitted from the backlight module pass through the array substrate and the liquid crystal molecular layer, and illuminate onto the color filter substrate. A part of the light rays are reflected or absorbed by the black matrix 2′, and do not transmit through the color filter layer 1′, thereby reducing the utilization of the light rays by the liquid crystal display.

### SUMMARY OF THE INVENTION

The disclosure of the present invention provides a display panel and a display device, for solving this technical problem, thereby improving the utilization of the light rays.

In one aspect of the present invention, a display panel comprises a color filter substrate comprising a plurality of sub pixels, each sub pixel is provided with a color filter layer therein,

wherein the display panel further comprises a light condensing substrate at one side of the color filter substrate facing a light source, and a light condensing structure is arranged at a corresponding position onto the light condensing substrate to the color filter layer.

In another aspect of the present invention, a display device comprises the display panel as described above.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic view of light rays transmitting through a color filter substrate in the prior art;

FIG. 2 is an exploded view of a display panel in accordance with an embodiment of the present invention;

FIG. 3 is a schematic view of the light rays transmitting through a light condensing substrate and the color filter substrate in accordance with an embodiment of the present invention;

FIG. 4 is a schematic view of the color filter substrate in accordance with one embodiment of the present invention;

FIG. 5 is a schematic view of the color filter substrate in accordance with another embodiment of the present invention;

FIG. 6 is a schematic view of the light condensing substrate in accordance with one embodiment of the present invention; and

FIG. 7 is a schematic view of the light condensing substrate in accordance with another embodiment of the present invention.

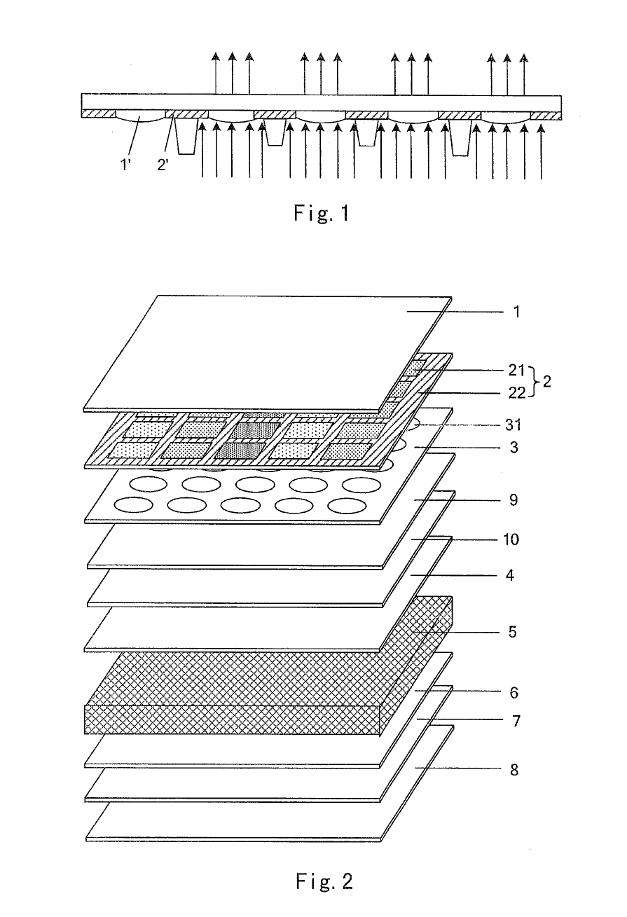

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In one embodiment of the present invention, it provides a display panel as shown in FIG. 2. The display panel includes a color filter substrate 2, which includes a plurality of sub pixels. Each sub pixel is provided with a color filter layer 21 therein. The display panel also includes a light condensing substrate 3 located at one side of the color filter substrate 2 facing a light source (i.e., a backlight module thereof). A light condensing structure 31 is provided at a corresponding position on the light condensing substrate 3 to the color filter layer 21.

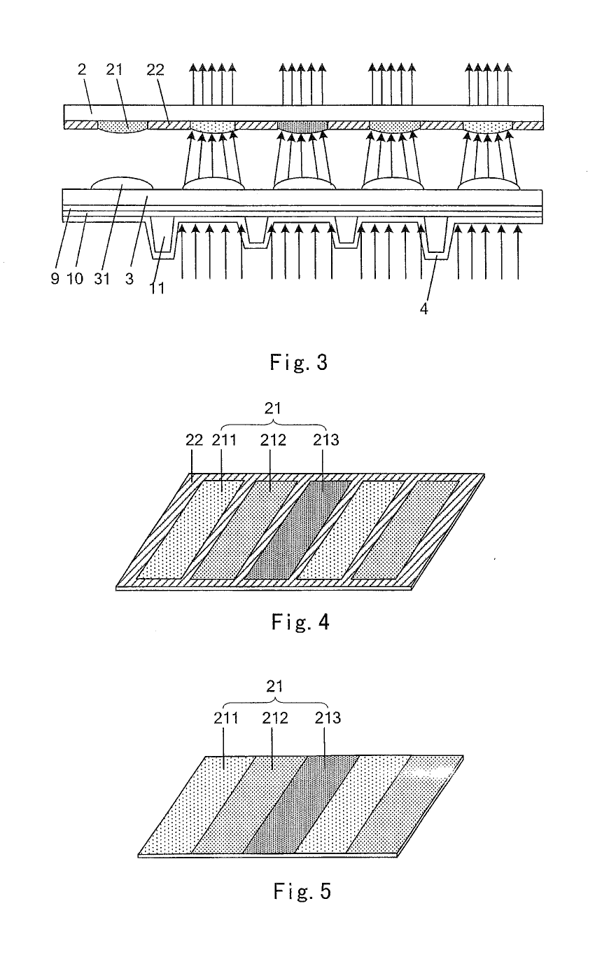

As shown in FIG. 3, when the light rays transmit the light condensing substrate 3, the light condensing structures 31 converge all the light rays onto the areas where the color filter layers 21 within the sub pixels are located, so that all the light rays can pass through the color filter layers 21 within the sub pixels. In this way, on one hand, the utilization of the light rays is improved, and on the other hand, a view angle can be reduced, so that it is possible to have a better anti-peeping effect. This results in applying said display panel into the display device having a relatively high safety requirement. For example, the above display panel can be applied into the bank automatic teller machines (ATM).

In addition, please be noted that the size of the light condensing structure 31 can be set as actually required, for example, in accordance with a refractive index of the material of the light condensing structure 31, the size of the color filter layer 21 within the sub pixel, a distance between the light condensing substrate 3 and the color filter substrate 2, and so on. It should be understood that the light condensing substrate 3 is typically disposed at a certain distance from the color filter substrate 2 (especially, the color filter layer 21 thereon), and such distance can be selected as required, by the skilled person. Therefore, the embodiment of the present invention does not make any limitation to this.

As described above, in the embodiment of the present invention, the light rays emitted from the light source firstly pass through the light condensing substrate, and then arrive at the color filter substrate. Since the light condensing structure is provided at a corresponding position on the light condensing substrate to the color filter layer, the light condensing structures will converge all the light rays into the areas where the color filter layers within the sub pixels are located, when the light rays transmit the light condensing substrate. Because all the light rays pass through the color filter layer within the sub pixels, the utilization of the light rays is improved.

The structures of the color filter substrate will be described in detail below, in conjunction with the accompanying drawings.

Specifically, as shown in FIGS. 2, 4 and 5, the color filter substrate 2 includes a plurality of sub pixels. Each sub pixel is provided with a color filter layer 21 therein. The color filter layer 21 includes a red color area 211, a green color area 212 and a blue color area 213, which are made by resin materials having the corresponding colors. The red, green, and blue color areas 211, 212, 213 can be distributed in many ways, as long as the pixel consisted of several adjacent sub pixels enables to display different colors. The embodiment of the present invention does not make any limitation to this.

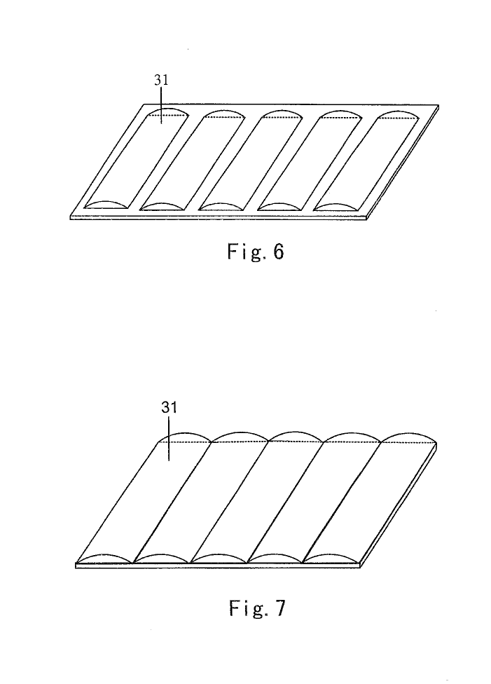

Illustratively, as shown in FIG. 2, the red, green, and blue color areas 211, 212, 213 are distributed in the form of a matrix. As shown in FIG. 4, the red, green, and blue color areas 211, 212, 213 are distributed in the form of spaced strips. As shown in FIG. 5, the red, green, and blue color areas 211, 212, 213 are distributed in the form of strips contacting with each other, where the intervals between different sub pixels are filled with the color filter layer 21.

Further, since the light condensing substrate is provided at a side of the color filter substrate facing the light source, and has a plurality of light condensing structures, the light condensing structures can converge all the light rays into the areas where the color filter layers within the sub pixels are located, so that no light rays illuminate the areas between different sub pixels, and no light leakage is present. Therefore, the color filter substrate in one embodiment of the present invention can be provided with the black matrix 22, or not be provided with the black matrix 22. In order to improve the contrast of the display panel and avoid the colors mixing, preferably, the black matrix 22 in the embodiment of the present invention is provided between the different sub pixels on the color filter substrate, and the black matrix 22 is formed of black color resin. Specifically, the black matrix 22 is disposed between the adjacent color filter layers 21.

With reference to the figures, the structures of the light condensing substrate will be described in detail below.

The light condensing structures 31 are provided at the corresponding positions of the light condensing substrate 3 to the color filter layers 21 in the sub pixels. As shown in FIGS. 2 and 3, the light condensing structure 31 in the embodiment of the present invention is a convex lens. Further, the light condensing structures 31 are arranged onto one side face of the light condensing substrate 3 facing the color filter substrate 2.

Please be noted that any distribution of the light condensing structures 31 on the light condensing substrate 3 is feasible, as long as all the light rays can be converged into the area where the color filter layers 21 within the sub pixels are located. The embodiment of the present invention does not make any limitation to this. Illustratively, as shown in FIG. 2, the light condensing structures 31 are distributed in the form of a matrix. As shown in FIG. 6, the light condensing structures 31 are distributed to be spaced apart from each other and in a form of strip. As shown in FIG. 7, the light condensing structures 31 are distributed to be contacted with each other and in a form of strip.

Further, in order to simply the producing method of the light condensing substrate 3, in the embodiment of the present invention, the light condensing structures 31 and the light condensing substrate 3 are integrally formed together. Of course, it is possible to provide the light condensing structures 31 and the light condensing substrate 3 as the separate parts, and then the light condensing structures 31 are fixed onto the light condensing substrate 3.

Below, the structures of the display panel are described in detail with reference to the accompanying drawings.

As shown in FIG. 2, the display panel includes an upper polarizer 1, the color filter substrate 2, the light condensing substrate 3, a first orientation film 4, a liquid crystal molecular layer 5, a second orientation film 6, an array substrate 7 and a lower polarizer 8, arranged successively.

Specifically, the upper and lower polarizers 7 and 8 are configured to allow the light rays polarized in a specific direction to pass through. The light transmission axes of them can have the same direction, or be perpendicular to each other, or at a suitable angle. Gate electrode lines and data lines crisscrossing to each other are provided on the array substrate 7, and each area surrounded by them forms a pixel unit. A pixel electrode and a thin film transistor are provided within the pixel unit. The thin film transistor decides the presence of the voltage on the pixel electrode and the scope of the voltage, so as to control occurring of deflection of the liquid crystal molecules within the liquid crystal molecular layer 5 and the degree of the deflection.

The first and second orientation films 4 and 6 are used to orientate and arrange the liquid crystal molecules within the liquid crystal molecular layer 5. Grooves are formed on the first and second orientation films 4 and 6 by friction. The grooves on the first orientation film 4 may be parallel to or perpendicular to the grooves on the second orientation film 6. Of course, they may be disposed at other suitable angels. In the embodiment of the present invention, the first orientation film 4 is located on the side or the side face of the light condensing substrate 3 facing away the color filter substrate 2.

Please be noted that since the light condensing substrate 3 and the array substrate 7 in the embodiment of the present invention are respectively located at two sides of the liquid crystal molecular layer 5, as shown in FIG. 2, the display panel in the embodiment of the present invention also includes a transparent protective layer 9 and a common electrode layer 10, in order to control the defecting state of the liquid crystal molecules within the liquid crystal molecular layer 5. In the embodiment of the present invention, the transparent protective layer 9, the common electrode layer 10 and the first orientation film 4 are successively provided on the side of the light condensing substrate 3 facing away the color filter substrate 2.

Further, the display panel also includes a spacing pad 11 provided between the common electrode layer 10 and the first orientation film 4. At this time, the first orientation film 4 needs to cover the spacing pad 11 and the area on the side of the light condensing substrate 3 facing away the color filter substrate 2 without the spacing pad, at the same time.

Please be noted that in the prior art, the first orientation film is typically directly located on the color filter substrate. Because the convex-concave structures such as the color filter layer, the black matrix and the spacing pad are provided on the color filter substrate, the flatness of the color filter substrate is worse, and thus the flatness of the first orientation film covering on the color filter substrate is worse. In this way, the grooves formed on the first orientation film by friction are not even, thereby adversely affecting the orientation and arrangement as well as the diffusion of the liquid crystal molecules. As a result, the display panel tends to occur the non-uniformity of the dark state. In contrast, the first orientation film 4 in the embodiment of the present invention is located at the side of the light condensing substrate 3 facing away the color filter substrate 2, and only the spacing pad 11 among the respective structures onto the side face of the light condensing substrate 3 facing away the color filter substrate 2 can affect the flatness degree thereof. Therefore, the flatness of the side face is better, so that the flatness of the first orientation film 4 is better. Further, the grooves formed on the first orientation film 4 by friction are uniform, facilitating the orientation and arrangement as well as diffusion of the liquid crystal molecules, and effectively improving the non-uniformity of the dark state of the display panel.

Furthermore, the embodiment of the present invention also provides a display device, which includes the display panel as described above. Specifically, the display device can be any product or component having the display function, such as a liquid crystal display panel, an electronic paper, an OLED display panel, a mobile phone, a tablet computer, a TV, a display screen, a notebook computer, a digital picture frame, a navigator or the like.

Although several exemplary embodiments have been shown and described, the present invention is not limited to those and it would be appreciated by those skilled in the art that various changes or modifications may be made in these embodiments without departing from the principles and spirit of the disclosure. These changes or modifications also fall within the scope of the present invention. The scope of the present invention is defined by the claims and their equivalents.

What is claimed is,

1. A display panel, comprising a color filter substrate comprising a plurality of sub pixels, wherein each sub pixel is provided with a color filter layer therein, wherein the display panel further comprises a light condensing substrate at one side of the color filter substrate facing a light source, and a light condensing structure is arranged at a corresponding position on the light condensing substrate to the color filter layer.

2. The display panel as claimed in claim 1, wherein the light condensing structure is a convex lens.

3. The display panel as claimed in claim 1, wherein the light condensing structure is provided onto one side face of the light condensing substrate facing the color filter substrate, and is spaced apart from the corresponding color filter layer by a certain distance.

4. The display panel as claimed in claim 2, wherein the light condensing structure is provided onto one side face of the light condensing substrate facing the color filter substrate, and is spaced apart from the corresponding color filter layer by a certain distance.

5. The display panel as claimed in claim 1, wherein the light condensing structures are distributed in the form of a matrix, the form of spaced strips, or the form of strips contacting with each other.

6. The display panel as claimed in claim 2, wherein the light condensing structures are distributed in the form of a matrix, the form of spaced strips, or the form of strips contacting with each other.

7. The display panel as claimed in claim 3, wherein the light condensing structures are distributed in the form of a matrix, the form of spaced strips, or the form of strips contacting with each other.

8. The display panel as claimed in claim 4, wherein the light condensing structures are distributed in the form of a matrix, the form of spaced strips, or the form of strips contacting with each other.

9. The display panel as claimed in claim 1, wherein the light condensing structures and the light condensing substrate are formed integrally, or
the light condensing structures and the light condensing substrate are separate parts and the light condensing structures are fixed onto the light condensing substrate.

10. The display panel as claimed in claim 1, wherein a black matrix is provided between two adjacent sub pixels.

11. The display panel as claimed in claim 1, wherein it further comprises a transparent protective layer, a common electrode layer and a first orientation film successively disposed onto the side of the light condensing substrate facing away the color filter substrate.

12. The display panel as claimed in claim 11, wherein a spacing pad is provided between the common electrode layer and the first orientation film.

13. The display panel as claimed in claim 11, wherein the display panel further comprises an upper polarizer at the side of the color filter substrate facing away the light condensing substrate, and a liquid crystal molecular layer, a second orientation film, an array substrate and a lower polarizer successively provided on the side of the first orientation film facing away the light condensing substrate.

14. A display device, comprising the display panel as claimed in claim 1.

15. The display device as claimed in claim 14, wherein the light condensing structure is a convex lens.

16. The display device as claimed in claim 14, wherein the light condensing structure is provided onto one side face of the light condensing substrate facing the color filter substrate, and is spaced apart from the corresponding color filter layer by a certain distance.

17. The display device as claimed in claim 15, wherein the light condensing structure is provided onto one side face of the light condensing substrate facing the color filter substrate, and is spaced apart from the corresponding color filter layer by a certain distance.

18. The display device as claimed in claim 14, wherein the light condensing structures are distributed in the form of a matrix, the form of spaced strips, or the form of strips contacting with each other.

19. The display device as claimed in claim 14, wherein a black matrix is provided between two adjacent sub pixels.

20. The display device as claimed in claim 14, wherein it further comprises a transparent protective layer, a common electrode layer and a first orientation film successively disposed onto the side of the light condensing substrate facing away the color filter substrate, wherein a spacing pad is provided between the common electrode layer and the first orientation film; and
the display panel further comprises an upper polarizer at the side of the color filter substrate facing away the light condensing substrate, and a liquid crystal molecular layer, a second orientation film, an array substrate and a lower polarizer successively provided on the side of the first orientation film facing away the light condensing substrate.
